(19) United States
(12) Patent Application Publication
(10) Pub. No.: US 2010/0231892 A1
(43) Pub. Date: Sep. 16, 2010

(54) METHOD OF MEASURING AND/OR JUDGING THE AFTERGLOW IN CERAMIC MATERIALS AND DETECTOR

(75) Inventors: Cornelis R. Ronda, Eindhoven (NL); Gunter Zeitler, Eindhoven (NL); Herbert Schreinemacher, Eindhoven (NL)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/377,294

(22) PCT Filed: Aug. 9, 2007
(86) PCT No.: PCT/IB07/53165

§ 371 Date: May 21, 2010

(30) Foreign Application Priority Data
Aug. 15, 2006 (EP) 06118927.0

(51) Int. Cl. G01J 3/00

(52) U.S. Cl. 356/51; 356/300

(57) ABSTRACT

The invention relates to a method of measuring and/or judging the afterglow in ceramic materials, especially Gd2θ2S materials and/or precursor materials by measuring the Eu-, Tb- and/or Yb-content.

### FIELD OF THE INVENTION

The present invention is directed to a method of measuring the afterglow in ceramic materials, especially Gd₂O₂S materials.

### BACKGROUND OF THE INVENTION

Fluorescent members for detecting high-energy radiation contain a phosphor that can absorb the radiation and convert it into visible light. The luminescent emission thereby generated is electronically acquired and evaluated with the assistance of light sensitive systems such as photodiodes or photomultipliers. Such fluorescent members can be manufactured of single-crystal materials, for example, doped alkali halides. Non-single-crystal materials can be employed as powdered phosphor or in the form of ceramic members manufactured there from.

A typical fluorescent ceramic material employed for detecting X-ray radiation between 10 to 200 keV is doped Gd₂O₂S, doped with e.g. Ce³⁺ or Pr³⁺. However, the use of Gd₂O₂S is somewhat diminished in case the Gd₂O₂S shows luminescent characteristics which are known as “afterglow”, i.e. that after the desired prompt fluorescence (determined by the intrinsic emission time of the specific activator ion used) a somewhat dimmer, but longer-lasting “second fluorescence” can be seen, which may also occur at wavelengths differing from the prompt fluorescence. In other words, afterglow can be defined as a non-instantaneous reaction of the stationary scintillator signal after having switched-off the X-ray photon exposure of the scintillator. This residual signal is sometimes called lag or often also afterglow. The afterglow is given as relative value to the stationary signal of the scintillator material under investigation and is normally evaluated as a function of time after the end of the X-ray pulse. In CT the relevant time domain of the afterglow signal is between 0.1 ms and 2 s, while the value should be well below 300 ppm at 5 ms and 20 ppm at 0.5 s to guarantee artifact free CT images. Afterglow is one of the key performance criteria for scintillators in CT applications.

### SUMMARY OF THE INVENTION

A first object of the present invention is to provide a method, by which the afterglow in Gd₂O₂S materials can be measured effectively.

This object is solved by a ceramic material according to claim 1 of the present invention. Accordingly, a method of measuring and/or judging the afterglow in an Gd₂O₂S:M fluorescent ceramic material whereby M represents at least one element selected from the group Pr, Dy, Sm, Ce, Nd and/or Ho and/or precursor materials of said ceramic material is provided, whereby the afterglow is measured and/or judged by measuring the Eu, Tb and/or Yb-concentration in said fluorescent ceramic materials and/or precursor materials.

Surprisingly the inventors have found out that it is possible to measure and/or to judge the afterglow of a Gd₂O₂S material by measuring the Eu, Tb and/or Yb-concentration in said material. Furthermore the inventors have found out that it is for a wide range of applications within the present invention possible to measure and/or to judge the afterglow of a Gd₂O₂S material by measuring the Eu, Tb and/or Yb-concentration in the precursor materials of said Gd₂O₂S material.

The term “precursor material” in the sense of the present invention means and/or includes materials, from which the Gd₂O₂S material is produced. A list of non-limiting examples for precursor materials includes GdCl₃, GdBr₃, GdI₃, Gd(NO₃)₃, Gd₂(SO₄)₃GdF₃, Gd₂S₃, Gd₂O₃, Gd₂(CO₃)₃, Gd₂(C₂O₄)₃ as well as the respective salts of the metals M selected from the group Pr, Dy, Sm, Ce, Nd and/or Ho.

Without being limited to any particular theory, the inventors believe that at least a great deal of the role of the Eu in causing afterglow in Gd₂O₂S materials is due to the following mechanism:

During the operation of the fluorescent ceramic material, part of the metal M in the Gd₂O₂S, which is usually present in the form of trivalent ions is oxidized as represented by the equation I:

M³⁺->M⁴⁺+e⁻ (I)

In case that M is Praseodymium (which is a preferred embodiment of the present invention) this equation is specified as in the equation Ia:

Pr³⁺->Pr⁴⁺+e⁻ (Ia)

A part of the electrons, which are released by the equation I (or Ia) will then react with Europium as shown in equation II:

Eu³⁺+e⁻->Eu²⁺ (II)

These Eu²⁺ ions will then—by capture of a hole—be further oxidized back to Eu³⁺ ions, which are however in an excited state and subsequently emit light (several emission lines) in a wavelength range of about 400-750 nm, with its most prominent emission in the range 580-640 nm, which shows considerable overlap with the Pr³⁺ emission spectrum (equation III)

h⁺+Eu²⁺->Eu³⁺+hν (400-750 nm) (III)

This results in an undesired afterglow of the ceramic material.

In contrast, afterglow contributions due to Tb are not caused by the mechanism described for Eu. Here, the intrinsic decay of the excited Tb ions plays a dominant role. This in turn indicates that the relevant time domain of the afterglow signal is below 10 ms, thus affecting the so-called short term afterglow domain only (<20 ms).

However for Yb, the inventors believe, that the mechanism is similar to Eu thus having a huge influence leading to undesired afterglow in the complete time domain relevant for CT (0.1 ms to 2 s).

In fact the Yb will react—correspondingly to the reaction of Eu as seen in equation III—as shown in equation IV:

h⁺+Yb²⁺->Yb³⁺+hν (approx. 980 nm) (IV)

According to a preferred embodiment of the present invention, the method according to the present invention comprises time-delayed spectroscopy.

The term “time delayed spectroscopy” in the sense of the present invention especially means and/or includes the end of the excitation of the ceramic material and/or precursor material at a time T₀ and a delayed start of a measurement after a time T₁.

According to a preferred embodiment of the present invention, the time T₀ refers to the time at which the intensity of laser pulse—which excites the emission (of Pr³⁺ and/or of Eu³⁺, Yb³⁺ etc.)—is less than 1% of its highest intensity implying that Tₒ is defined as the starting point for any delayed emission processes.

In this embodiment it is especially preferred the laser pulse shape and especially its falling edge has to be chosen such that the time difference defined by the time stamps corresponding to e.g. a 99% intensity level and a 1% intensity level is smaller than any relevant intrinsic or delayed emission process. This time difference is preferably less than 1% of the fastest emission decay time to guarantee a proper time delayed spectroscopic fingerprint measurement.

T₁ is the time at which the time delayed spectroscopy measurement using e.g. a CCD camera is started and T₂ is the time at which the measurement is stopped.

According to a preferred embodiment of the present invention, the measurement includes the measurement of the emission of the material in the wavelength range of ≧370 nm to ≦1100 nm, preferably ≧600 nm to ≦1050 nm.

According to a preferred embodiment of the present invention, T₁−T₀ is ≧1 μs to ≦1000 μs, preferably ≧20 μs to ≦500 μs. This increases for a wide range of applications within the present invention the accuracy of the measurement and/or judgement of the afterglow.

According to a preferred embodiment it has been shown that in a wide range of applications it may be advantageous that T₁−Tₒ is at least 20 μs to prevent detection of direct (non-delayed) Pr⁺ emission that would otherwise by far dominate any other emission processes.

According to a preferred embodiment of the present invention, the time-delayed spectroscopy includes the excitation of the ceramic material and/or precursor material with at least one wavelength in a wavelength area of 100 nm to 300 nm, preferably ≧240 nm to ≦270 nm.

According to a preferred embodiment of the present invention, the time delayed spectroscopy is stopped after a time T₂ whereby T₂−T₁ is ≧500 ms, preferably ≧1 s.

According to a preferred embodiment of the present invention, the time-delayed spectroscopy is stopped after a time T₂ whereby T₂−T₁ is ≦2 s, preferably ≦1.5 s, more preferred ≦1 s.

It has been shown advantageous in practice within a wide range of applications of the present invention to choose T₂ as described above, since then enough information may be gathered, however, when T₂ is too long, the signal/noise ratio may disadvantageously decrease.

It should be noted that according to a further embodiment of the present invention in addition the emission spectrum during laser excitation can be measured to determine also the Pr³⁺ emission spectrum. However, this spectrum will in most applications also include minor contributions of e.g. Eu³⁺, Yb³⁺ etc. Having measured the time delayed emission spectrum as well as the Pr-emission spectrum one can further analyse the intensity ratios of these emission bands in these spectra to obtain quantitative information. As mentioned above, also T₁−Tₒ can be used to gain further insights (intensity ratio as function of delay time).

According to a preferred embodiment of the present invention, the method comprises time resolved spectroscopy.

The term “time resolved spectroscopy” especially means and/or includes the continuous measurement over a certain time, which is preferably ≧50 μs to 1 s, and more preferably ≧100 μs to ≦500 ms.

According to a preferred embodiment of the present invention, the time resolved spectroscopy includes the measurement of the emission of the ceramic material and/or precursor material with at least one wavelength in a wavelength area of ≧600 nm to ≦650 nm, especially to determine the Eu-concentration and the corresponding afterglow contribution.

According to a preferred embodiment of the present invention, the time resolved spectroscopy includes the measurement of the emission of the ceramic material and/or precursor material with at least one wavelength in a wavelength area of ≧930 nm to ≦1100 nm, especially to determine the Yb-concentration and the corresponding afterglow contribution.

According to a preferred embodiment of the present invention, the time resolved spectroscopy includes the measurement of the emission of the ceramic material and/or precursor material with at least one wavelength in a wavelength area of ≧370 nm to ≦570 nm (more preferably between 530 nm to 560 nm), to determine the Tb-concentration and the corresponding afterglow contribution.

It should be noted that according to a wide range of applications within the present invention, the above mentioned regions for Eu, Tb and/or Yb determination are chosen such that any additional contributions from other Pr³⁺ emission lines can be excluded or ignored. In this way, the strength of the afterglow signal (caused by e.g. time delayed Eu³⁺, Tb³⁺ and/or Yb³⁺ emission) can be measured at any time, using the Pr³⁺ emission intensity as normalizer to obtain time resolved afterglow curves.

According to a further and insofar preferred embodiment of the present invention, the information used is the intensity ratio of the investigated spectral regions, also as a function of time.

According to a preferred embodiment of the present invention, the time resolved spectroscopy includes the excitation of the ceramic material and/or precursor material with at least one wavelength in a wavelength area of ≧100 nm to ≦300 nm, preferably ≧240 nm to ≦270 nm.

According to a preferred embodiment of the present invention, the method comprises continuous excitation spectroscopy.

The term “continuous excitation spectroscopy” especially means and/or includes the measurement of the emission of the ceramic material and/or precursor material in certain different wavelength areas, which are then compared to each other in order to obtain the Eu, Tb and/or Yb-concentration. The term “continuous excitation spectroscopy” especially means and/or includes that a continuous light source is used, and again the photon energy is chosen such that the excitation is via the band gap. The emission spectrum is measured e.g. via a CCD camera.

According to a preferred embodiment of the present invention, the continuous excitation spectroscopy includes the measurement of the emission of the ceramic material and/or precursor material with at least one wavelength in a wavelength area of ≧600 nm to ≦650 nm, especially to determine the Eu-concentration and judge the corresponding afterglow contribution.

According to a preferred embodiment of the present invention, the continuous excitation spectroscopy includes the measurement of the emission of the ceramic material and/or precursor material with at least one wavelength in a wavelength area of ≧930 nm to ≦1050 nm, especially to determine the Yb-concentration and judge the corresponding afterglow contribution.

According to a preferred embodiment of the present invention, the continuous excitation spectroscopy includes the measurement of the emission of the ceramic material and/or precursor material with at least one wavelength in a wavelength area of ≧370 nm to ≦570 nm, more preferably between ≧530 nm to ≦560 nm, to determine the Tb-concentration and judge the corresponding afterglow contribution.

The present invention furthermore relates to a detector for measuring the afterglow in an Gd₂O₂S:M fluorescent ceramic material whereby M represents at least one element selected from the group Pr, Dy, Sm, Ce, Nd and/or Ho and/or precursor materials of said ceramic material using one or more of the methods described above.

According to an embodiment of the present invention, the detector comprises a laser, preferably an YAG-based laser and/or a CCD-based detector with a time gated spectrally variable detection range.

The present invention furthermore relates to the use of a detector and/or any of the methods described above in one or more of the following systems:
systems adapted for medical imaging
systems for judging the quality of the Gd₂O₂S:M fluorescent ceramic material whereby M represents at least one element selected from the group Pr, Dy, Sm, Ce, Nd and/or Ho and/or the precursor materials
systems for manufacturing the Gd₂O₂S:M fluorescent ceramic material whereby M represents at least one element selected from the group Pr, Dy, Sm, Ce, Nd and/or Ho

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, characteristics and advantages of the object of the invention are disclosed in the subclaims, the figures and the following description of the respective figures and examples, which—in an exemplary fashion—show a preferred embodiment of a detector according to the invention.

FIG. 1 shows two very schematic diagrams of intensity vs. time for a) a laser pulse used I time-delayed spectroscopy (above) and b) the emission of the probe which was excited using the laser (below) according to a first embodiment of the present invention

FIG. 2 shows an emission spectrum of a first GOS powder measured with time-delayed spectroscopy

FIG. 3 shows an emission spectrum of a different GOS powder measured with time-delayed spectroscopy; and

FIG. 4 shows the afterglow spectra of two GOS-ceramics produced out of the GOS powders of FIGS. 2 and 3

FIG. 5 shows a very schematic view of a detector according to a further embodiment of the present invention

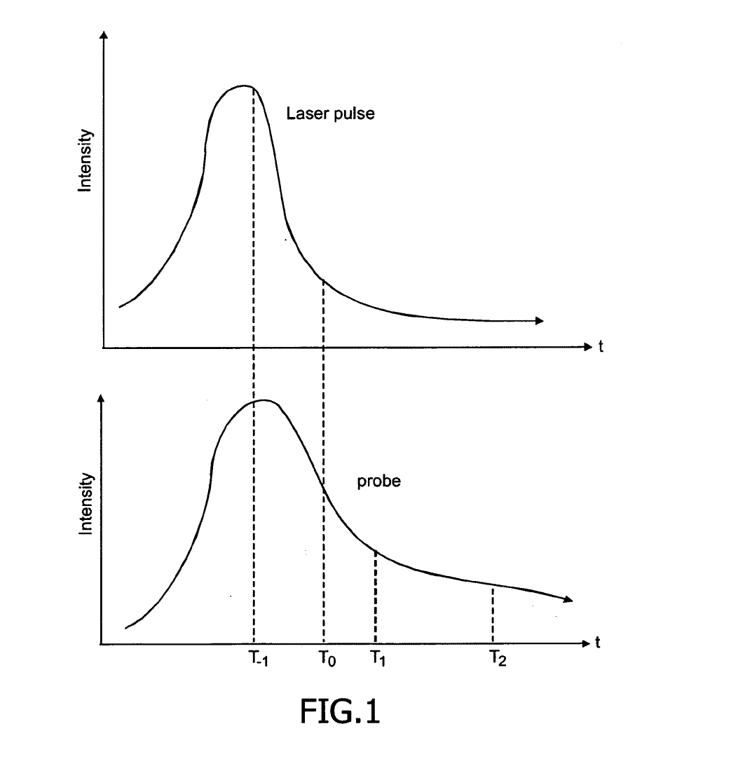

FIG. 1 shows two very schematic diagrams of intensity vs. time for a) a laser pulse used I time-delayed spectroscopy (the above diagram) and b) the emission of the probe which was excited using the laser (the below diagram) according to a first embodiment of the present invention. It should be stressed that both curves are highly schematic and are merely used for illustrating the time-delayed spectroscopy process.

In FIG. 1, the time Tₒ is indicated to that time at which the intensity of laser pulse—whose intensity is shown in the above diagram—is less than 1% of its highest intensity implying that Tₒ is defined as the starting point for any delayed emission processes. The “99%”-intensity-time is indicated as “T₋₁”.

In this embodiment the laser pulse shape and especially its falling edge was chosen such that the time difference defined by the time stamps corresponding to e.g. a 99% intensity level (“T₋₁”) and the 1% intensity level “T₀” was smaller than any relevant intrinsic or delayed emission process of the probe as can be seen in the below diagram.

The time indicators “T₁” and “T₂” indicate when the measuring was started and stopped. However, it should be noted that FIG. 1 is highly schematic and T₂ will be in most applications much longer.

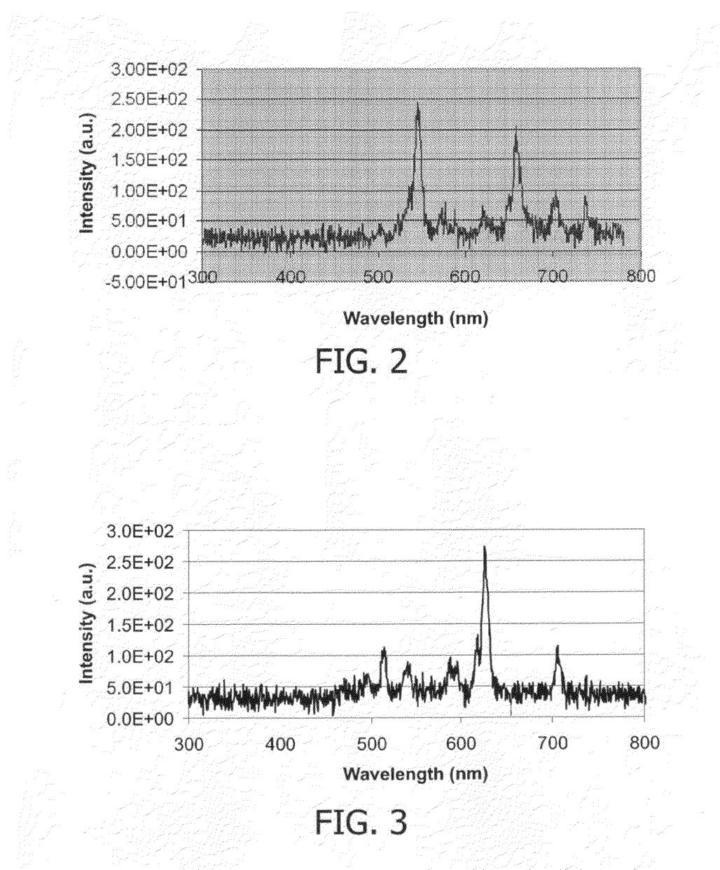

FIG. 2 shows an emission spectrum of a first GOS powder measured with time-delayed spectroscopy. The delay in time (=T₁−T₀) is 10 ms after a laser pulse in the wavelength area of 266 nm. T₀ was set as described in FIG. 1.

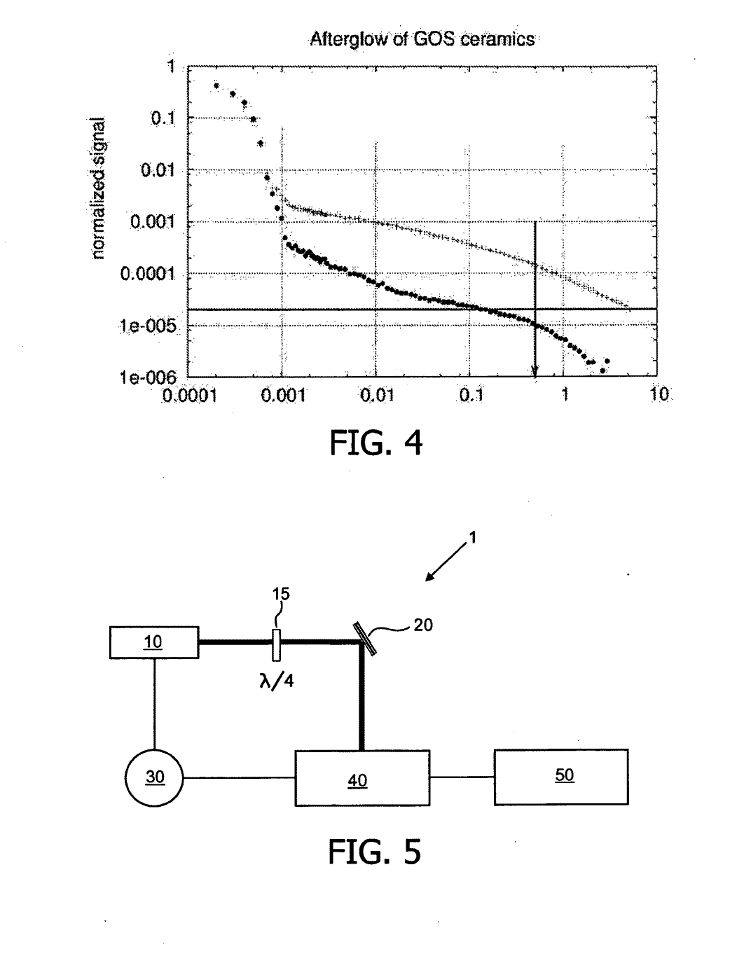

From the spectra it can be obtained that the Eu-content is quite low (i.e. <1 ppm Eu), while there is a small content of Tb (peak around 540 nm). As will be seen in FIG. 4, this Tb content leads to afterglow in the time domain below 10 ms (short term afterglow).

FIG. 3 shows an emission spectrum of a different GOS powder measured with time-delayed spectroscopy. Again, the delay in time (=T₁−T₀) is 10 ms after a laser pulse in the wavelength area of 266 nm. T₀ was set as described in FIG. 1.

From the spectra it can be obtained that the Eu-content is approximately 10 ppm.

It should be noted that the intensities of FIG. 2 and FIG. 3 cannot be directly compared in intensity. In FIG. 3, the Eu-emission peaks at 620-630 nm and at around 700 nm are dominating by far the small Tb contribution at around 540 nm, which leads to afterglow in the time domain below 10 ms only (short term afterglow)—similar to the GOS powder of FIG. 2.

FIG. 4 shows the afterglow spectra of two GOS-ceramics produced out of the GOS powders of FIGS. 2 and 3. The two GOS ceramics were produced out of the GOS powder accordingly to EP 05110054.3, which is hereby fully incorporated by reference.

In FIG. 4, the afterglow spectra of the GOS ceramic made out of the GOS powder of FIG. 2 is indicated by dots (“”) whereas the afterglow spectra of the GOS ceramic made out of the GOS powder of FIG. 3 is indicated by plusses (“+”).

It can be seen that the GOS ceramic made out of the powder with the lower Eu-content has a significantly lower afterglow. In fact, only this ceramic may considered acceptable.

However, due to the fact that both GOS ceramics were made of powder contaminated with small amounts of Tb, there is a slight increase in the afterglow curves visible at a time zone around 1 ms (different slope of the afterglow curve). However, in both ceramics the Tb content is small enough to cause no unacceptable afterglow, however, according to the present invention, this short term afterglow can be measured and/or judged as well.

It should be noted that in FIG. 4 effects of the measurement equipment, which prohibit revealing the afterglow, dominate the shape of the afterglow curve below 600 μs.

In this invention, acceptable GOS-ceramic is defined as having an afterglow of lower than 20*10⁻⁶ after 0.5 s. This point is indicated by the two thick lines in FIG. 4. It can be clearly seen, that only the GOS-ceramic made out of the powder of FIG. 2 is acceptable, whereas the other GOS-ceramic is not.

It is therefore possible for a wide range of applications within the present invention to tell merely from the measurement of the Eu-, Tb- and/or Yb content of an Gd₂O₂S:M fluorescent ceramic material whereby M represents at least one element selected from the group Pr, Dy, Sm, Ce, Nd and/or Ho and/or precursor materials of said ceramic material, if this Gd₂O₂S:M fluorescent ceramic material has an acceptable afterglow or not.

Since it is for a wide range of applications within the present invention possible to deduce from the Eu-, Tb- and/or Yb-content of the precursor materials to the afterglow of the final Gd₂O₂S:M fluorescent ceramic material, it is possible to greatly increase the efficacy and/or yield of the production of these Gd₂O₂S:M fluorescent ceramic materials.

FIG. 5 shows a very schematic view of a detector 1 according to a further embodiment of the present invention. The detector comprises a Nd:YAG-Laser 10 which emits light with a wavelength of λ=1064 nm towards the material 20 which is to be characterized. In the optical path a frequency quadrupling unit 15 is provided, which changes the wavelength to λ=266 nm. The spectra of the material 20 is characterized by an CCD-detector 40 which is synchronized by a trigger unit 30. The CCD-detector is equipped with a time gated spectrally variable detection range. Finally the data is collected and analyzed by a computer 50.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. A method of measuring and/or judging the afterglow in an Gd₂O₂S:M fluorescent ceramic material whereby M represents at least one element selected from the group Pr, Dy, Sm, Ce, Nd and/or Ho and/or precursor materials of said ceramic material, whereby the afterglow is measured and/or judged by measuring the Eu-, Tb- and/or Yb-concentration in said fluorescent ceramic materials and/or precursor materials.

2. The method of claim 1, whereby the method comprises time delayed spectroscopy.

3. The method of claim 2, whereby the time delayed spectroscopy includes the end of the excitation of the ceramic material and/or precursor material at a time T₀ and a delayed start of the measurement after a time T₁ whereby T₁−T₀ is ≧15 μs to ≦1000 μs. The time delayed spectroscopy is stopped after a time T₂ whereby T₂−T₁ is ≧500 ms, preferably ≧1 s.

4. The method of claim 1 whereby the time delayed spectroscopy includes the measurement of the emission of the material in the wavelength range of ≧370 nm to ≦1100 nm, preferably ≧600 nm to ≧1050 nm.

5. The method of claim 1, whereby the method comprises time resolved spectroscopy.

6. The method of claim 5, whereby the time resolved spectroscopy includes the emission of the ceramic material and/or precursor material with at least one wavelength in a wavelength area of ≧600 nm to ≦650 nm, especially to determine the Eu-concentration and afterglow contribution,
and/or
the emission of the ceramic material and/or precursor material with at least one wavelength in a wavelength area of ≧930 nm to ≦1050 nm, especially to determine the Yb-concentration and afterglow contribution.
and/or
the emission of the ceramic material and/or precursor material with at least one wavelength in a wavelength area of ≧370 nm to ≦570 nm, especially to determine the Tb-concentration and afterglow contribution.

7. The method of claim 1, whereby the method comprises continuous excitation spectroscopy.

8. The method of claim 7, whereby the continuous excitation spectroscopy includes the emission of the ceramic material and/or precursor material with at least one wavelength in a wavelength area of ≧ 600 nm to ≦650 nm, especially to determine the Eu-concentration and afterglow contribution,
and/or
the emission of the ceramic material and/or precursor material with at least one wavelength in a wavelength area of ≧930 nm to ≦1050 nm, especially to determine the Yb-concentration and afterglow contribution,
and/or
the emission of the ceramic material and/or precursor material with at least one wavelength in a wavelength area of ≧ 370 nm to ≦570 nm, especially to determine the Tb-concentration and afterglow contribution.

9. A detector for measuring the afterglow in an Gd₂O₂S:M fluorescent ceramic material whereby M represents at least one element selected from the group Pr, Tb, Dy, Sm, Ce and/or Ho and/or precursor materials of said ceramic material by a method of claim 1.

10. Use of a detector of claim 9 in one or more of the following systems:
systems adapted for medical imaging
systems for judging the quality of the Gd₂O₂S:M fluorescent ceramic material whereby M represents at least one element selected from the group Pr, Dy, Sm, Ce, Nd and/or Ho and/or the precursor materials
systems for manufacturing the Gd₂O₂S:M fluorescent ceramic material whereby M represents at least one element selected from the group Pr, Dy, Sm, Ce, Nd and/or Ho.

11. A method of determining afterglow comprising measuring the concentration of Eu, Tb or Yb in a fluorescent ceramic material using spectroscopy.

12. The method of claim 11 wherein the spectroscopy is one of time delayed spectroscopy, time resolved spectroscopy and continuous excitation spectroscopy.
